(19) United States
(12) Patent Application Publication
(10) Pub. No.: US 2005/0111032 A1
(43) Pub. Date: May 26, 2005

(54) Method and apparatus for controlling interface of printing data between clients and printers

(76) Inventors: Jin-tack Lee, Seoul (KR); Seung-soo Oak, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/946,122

(22) Filed: Sep. 22, 2004

(30) Foreign Application Priority Data
Nov. 25, 2003 (KR) 2003-84187

(51) Int. Cl. G06F 15/00

(52) U.S. Cl. 358/1.15

(57) ABSTRACT

A method and an apparatus for controlling the interface between clients and printers for the printing of data are provided. The method comprises setting interface paths so that network ports connecting each of a plurality of clients to the printer server correspond to printer ports for connecting each of a plurality of printers to the printer server; searching an interface path for data received from a client among the clients from the set interface paths to be printed. The data is transmitted to a printer among the printers via the searched interface path.

### BACKGROUND OF THE INVENTION

This application claims the benefit under 35 U.S.C. §119(a) of Korean Patent Application No. 2003-84187, filed on Nov. 25, 2003, in the Korean Intellectual Property Office, the entire disclosure of which is incorporated herein by reference.

1. Field of the Invention

The present invention relates to the interface between a plurality of clients and a plurality of network printers for printing data. More particularly, the present invention relates to a method and an apparatus for controlling the interface between clients and printers in which printing data received from each of the plurality of clients connected to a printer server via a network is simultaneously printed by a plurality of printers.

2. Description of the Related Art

A printer server forms a network with clients connected to a local area network (LAN) via a network port and transmits printing data to each of the connected printers via one or more printer ports such as a communication (COM) port, a line print terminal (LPT) port, and a universal serial bus (USB) port. The COM port is a serial port for communication, and the LPT port is a parallel port for connection to a printer or other devices. The USB port is a kind of serial port that provides an interface between a plug and play peripheral device such as an audio player, a joystick, a keyboard, a telephone, a scanner, or a printer, and a computer. The USB port is a kind of serial port that has a faster communication speed than the communication speed of a general serial port. The printer server may include two or more COM ports or LPT ports, or USB ports. The printer server includes a CPU, a memory, and a server program. The CPU executes a program that controls the interface between clients and network printers for printing data. The memory stores the program for a client and network printer interface that allows the printing of data or allows execution of the program. The server program receives the printing data via the network.

Meanwhile, a client includes a printer driver, which converts the user's printing data into an output form compatible with a printer, and a network port control program, which transmits the printing data to the printer server. The printer server should be connected to a printer port of the printer requested to print the data. A path for the printing data is allocated by a module called a spooler. The network port control program has a function for adding a network port that communicates with the printer server to the client via a network and a function for transmitting the printing data to the printer server via the network.

If a printing instruction of the printing data is given by a user, the printing data is converted into the output form (for example, PCL or Postscript etc.) of the predetermined printer in the printer driver and transmitted to the spooler. Information on the printer port connected to the printer driver is obtained from the spooler, and the printing data is transmitted to the printer server by the network port control program. The printer server transmits the printing data received from the client to the predetermined printer via the printer port.

However, in order to process the printing requests of a plurality of clients, even though the printer server receives a plurality of printing data, the printer server can transmit the printing data via only a basic printer port set by a printer server manager. Then, printing is performed by only a predetermined printer connected to the basic printer port. The printer server cannot set a different printer port to each client simultaneously. Thus, even though the printer server forms a network with a plurality of printers, while a printer performs a printing operation, different printers cannot print different printing data because the print data can only be sent to a predetermined printer port.

### SUMMARY OF THE INVENTION

The present invention provides a method of controlling the interface between clients and printers for printing data by which a plurality of interface paths corresponding to network ports and printer ports are set. The printing data is transmitted to each printer via the set path. Each of the print jobs comprising printing data is simultaneously printed by a plurality of printers.

The present invention also provides an apparatus for controlling an interface between clients and printers for printing data by which interface paths corresponding to network ports and printer ports are set. Printing data is transmitted to each printer via the set path and the printing data from each client is simultaneously printed by a plurality of printers.

According to an aspect of the present invention, there is provided a method of controlling an interface between clients and printers for printing data. The method comprises setting interface paths so that network ports for connecting each of a plurality of clients to the printer server correspond to printer ports for connecting each of a plurality of printers to the printer server. Additionally, the method comprises the steps of searching an interface path for printing data received from a client from among the plurality of clients from the set interface paths and transmitting the printing data to a printer selected from among the printers via the searched set interface path.

According to another aspect of the present invention, there is provided an apparatus for controlling an interface between clients and printers for printing data. The apparatus comprises an interface path setting portion, which sets interface paths so that network ports for connecting each of a plurality of clients to the printer server correspond to printer ports for connecting each of a plurality of printers to the printer server. Additionally, the apparatus comprises a path search controlling portion, and a data transmission controlling portion. The path search controlling portion controls the printer server to search an interface path for printing data received from a client among the plurality of clients from the set interface paths. The data transmission controlling portion controls the printer server to transmit the printing data to a printer from among the plurality of printers via the interface path found by the path search controlling portion.

### BRIEF DESCRIPTION OF THE DRAWINGS

The above aspects and advantages of the present invention will become more apparent by describing in detail exemplary embodiments thereof with reference to the attached drawings in which:

FIG. 1 illustrates a network environment for explaining a method of controlling an interface of printing data between clients and printers according to an embodiment of the present invention;

FIG. 2 is a flowchart illustrating a method of controlling an interface of printing data between clients and printers according to an embodiment of the present invention;

FIG. 3 is a flowchart illustrating step 12 of FIG. 2 according to an embodiment of the present invention;

FIG. 4 is a flowchart illustrating step 14 of FIG. 2 according to an embodiment of the present invention;

FIG. 5 is a block diagram illustrating an apparatus for controlling an interface between clients and printers according to an embodiment of the present invention;

FIG. 6 is a block diagram of the path search controlling portion of FIG. 5 according to an embodiment of the present invention; and

FIG. 7 is a block diagram of the data transmission controlling portion of FIG. 5 according to an embodiment of the present invention.

### DETAILED DESCRIPTION OF THE EXEMPLARY EMBODIMENTS

A method of controlling the interface between clients and printers for printing data according to an embodiment of the present invention will now be described with reference to the accompanying drawings.

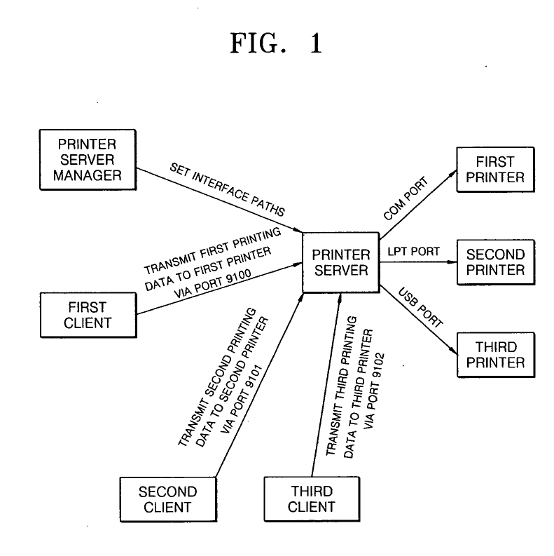

FIG. 1 illustrates an example of a network environment for explaining a method of controlling an interface between clients (first through third clients) and printers (first through third printers) for printing data according to an embodiment of the present invention. A printer server forms a network with a printer server manager, first through third clients, and first through third printers. Of course, the network may comprise more clients and or printers.

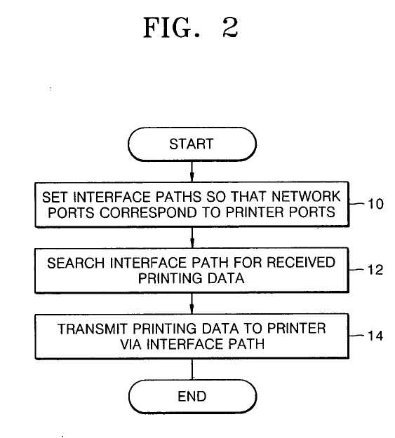

FIG. 2 is a flowchart illustrating a method of controlling an interface between clients and printers for printing data according to an embodiment of the present invention. The method of controlling an interface between clients and printers for printing data comprises the step of searching a predetermined interface path for printing data from among a plurality of set interface paths and transmitting printing data via the predetermined interface path (steps 10 through 14).

In step 10, a plurality of interface paths are set so that the network ports for connecting each of a plurality of clients to a printer server correspond to printer ports for connecting each of a plurality of printers to the printer server.

Each of the network ports is a path for connecting each of the plurality of clients to the printer server, and each of the printer ports is a path for connecting each of the plurality of printers to the printer server. The plurality of interface paths are formed by one-to-one matching of the network ports and the printer ports so that a plurality of printing jobs, which comprise printing data, received from the plurality of clients via the network ports are transmitted to each of the printers. The interface paths are preferably set in the form of a lookup table. Table 1 shows an example of interface paths set in the form of the exemplary lookup table.

TABLE 1

| Interface paths | Network ports | Printer ports |
|---|---|---|
| 1 | 9100 | COM |
| 2 | 9101 | LPT |
| 3 | 9102 | USB |

In Table 1, an interface path 1 is set so that printing data received via a network port 9100 is output via a printer port COM and transmitted to a printer connected to the printer port COM. In addition, an interface path 2 is set so that different printing data received via a network port 9101 is output via a printer port LPT and transmitted to a printer connected to the printer port LPT. In addition, an interface path 3 is set so that different data for printing received via a network port 9102 is output via the printer port USB to the printer connected to the printer port USB.

FIG. 1 illustrates a network environment in which a network port 9100 is bound to the first client, a network port 9101 is bound to the second client, and a network port 9102 is bound to the third client by the printer driver of each respective client.

Comparing the network environment of FIG. 1 with Table 1, if the first client's printing data is received via the network port 9100. The interface path 1 provides the network environment in which the first printing data is transmitted to a first printer connected to the printer port COM, which corresponds to the network port 9100. Similarly, if printing data of the second client is received via the network port 9101, the interface path 2 provides the network environment in which the second client's printing data is transmitted to a second printer connected to the printer port LPT, which corresponds to the network port 9101. In addition, if the third client's printing data is received via the network port 9102, the interface path 3 provides the network environment in which the third client's printing data is transmitted to a third printer connected via the printer port USB, which corresponds to the network port 9102.

Meanwhile, the first printer connected to the printer port COM and the second printer connected to the printer port LPT are preferably printer control language (PCL) printers, and the third printer connected to the printer port USB is preferably a Postscript printer. Of course, a network having more or less PCL or Postscript printers is well known to one of ordinary skill in the art. Additionally, other printer control languages such as printer job language (PJL) and EPSON Job Control language (EJL) and the like, are well known to one of ordinary skill in the art.

As shown in FIG. 1, the interface paths are preferably set by the printer server manager.

After step 10, in step 12, an interface path of the interface paths set in step 10 is searched for printing data received from a client from among the plurality of clients. For example, if the client from among the plurality of clients is the second client of FIG. 1. The interface paths from the set of interface paths 1, 2, and 3 is searched for the second client's printing data received from the second client.

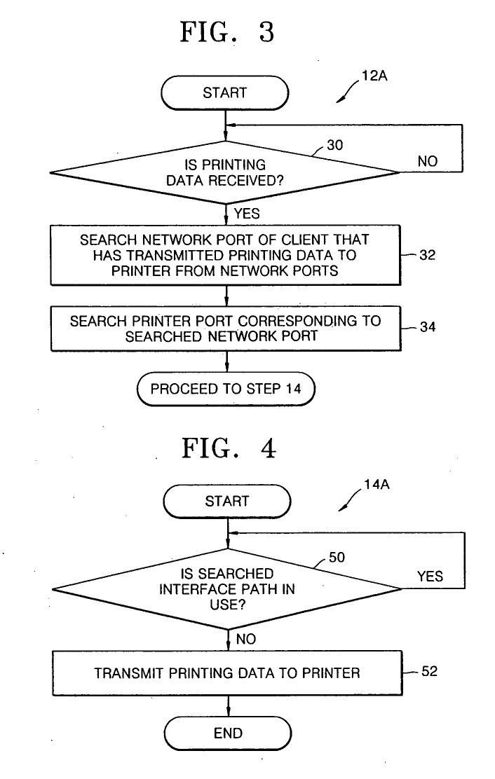

FIG. 3 is a flowchart illustrating an alternative step 12A to step 12 of FIG. 2 according to an embodiment of the present invention. Step 12A comprises steps 30 through 34 for searching a network port for received printing data and a printer port corresponding to the network port.

In step 30, it is determined whether printing data is received from clients. Step 30 is performed repeatedly until printing data is received from a client.

However, if it is determined that the printing data is received from the clients, in step 32, the network port of a client that has transmitted the printing data to a printer is searched from the plurality of network ports. For example, if the received printing data is the second client's printing data of FIG. 1, a network port 9101 corresponding to a path for transmission of the second printing data is searched from the network ports of the set interface paths.

In step 34, the printer port of the interface path corresponding to the searched network port is searched from the plurality of printer ports. For example, if the network port 9101 corresponding to interface path 2 is searched, the printer port LPT corresponding to the network port 9101 of interface path 2 is searched from the plurality of printer ports.

The interface path for transmission of the printing data to a predetermined printer is determined by searching the printer port.

Referring back to FIG. 2, after step 12, in step 14, the printing data is transmitted to the printer among the plurality of printers via the searched interface path. For example, if the received printing data is the second client's printing data of FIG. 1 via the network port 9101, the second printing data is transmitted to the second printer connected to the printer port LPT corresponding to the network port 9101 of interface path 2.

FIG. 4 is a flowchart illustrating step 14 of FIG. 2 according to another embodiment of the present invention. The alternative step 14A comprises the steps of determining whether the interface path is in use and transmitting printing data to the printer (steps 50 and 52). In step 50, it is determined whether the searched interface path is in use for printing different printing data. For example, if the interface path 2 is searched in step 12, it is determined whether the network port 9101 of the searched interface path 2 and the printer port LPT corresponding to the network port 9101 are provided as a network path for data transmission for printing previously sent different printing data. If it is determined that the predetermined searched interface path is in use for printing different printing data, the above-described step 50 is performed repeatedly until it is determined that the interface path is no longer in use. However, if it is determined that the searched interface path is not in use, in step 52, the printing data is transmitted to the printer corresponding to the searched interface path. For example, if the received printing data is the second client's printing data of FIG. 1, the second printing data is transmitted to the second printer connected to the printer port LPT via the interface path 2.

By performing the above-described steps, the printer server performs printing by transmitting printing data to a printer by a predetermined client's request and simultaneously performs printing by transmitting different printing data received from different clients to a different printer.

An apparatus for controlling the interface between clients and printers will now be described with reference to the accompanying drawings.

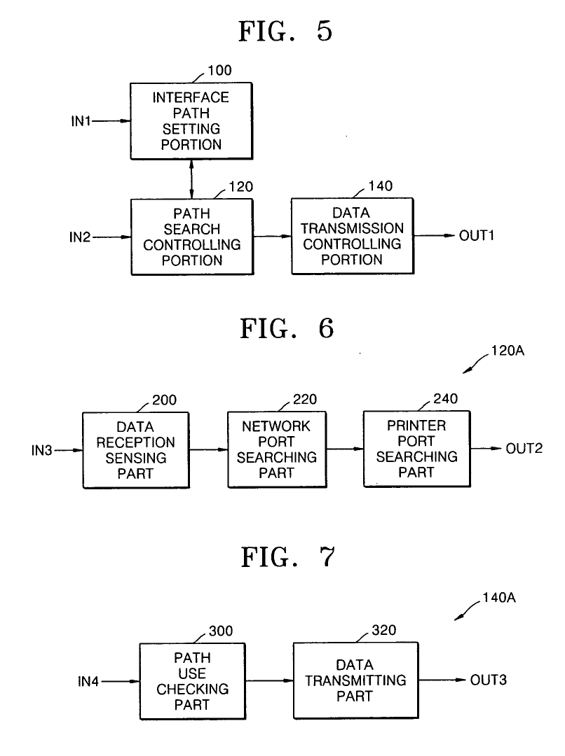

FIG. 5 is a block diagram illustrating an apparatus for controlling the interface between clients and printers according to an embodiment of the present invention. The apparatus for controlling an interface between clients and printers includes an interface path setting portion 100, a path search controlling portion 120, and a data transmission controlling portion 140.

In order to perform step 10 of FIG. 2, the interface path setting portion 100 sets an interface path so that the network ports for connecting each of a plurality of clients to a printer server correspond to printer ports for connecting each of a plurality of printers to the printer server. For example, the interface path setting portion 100 sets interface paths so that the network ports correspond to the printer ports, in response to an interface setting request signal input through an input terminal IN1 from a printer server manager shown in FIG. 1. The interface path setting portion 100 draws the set interface paths in response to a request signal of the path search controlling portion 120.

The interface path setting portion 100 sets the interface paths in the form of a lookup table, as shown above in Table 1.

In order to perform step 12 of FIG. 2, the path search controlling portion 120 controls the printer server to search an interface path from the plurality of set interface paths for printing data received from a client from among a plurality of clients . The path search controlling portion 120, in response to the printing data received through an input terminal IN2 from a client, requests the interface path setting portion 100 for the interface path corresponding to a path through which the received printing data is transmitted.

The path search controlling portion 120 controls the printer server to search the interface path from among the plurality of interface paths set by the interface path setting portion 100 and outputs a controlling result to the data transmission controlling portion 140.

FIG. 6 is a block diagram of an exemplary path search controlling portion 120 of FIG. 5 according to an embodiment of the present invention. The path search controlling portion 120A includes a data reception sensing part 200, a network port searching part 220, a printer port searching part 240.

In order to perform step 30 of step 12A of FIG. 3, the data reception sensing part 200 senses whether printing data is received from the clients through an input terminal IN3 and outputs a sensing signal to the network port searching part 220.

In order to perform step 32, the network port searching part 220 searches the network port of the client that has transmitted printing data to a printer from the plurality of network ports of the set interface paths in response to the sensing signal input from the data reception sensing part 200. The network port searching part 220 outputs a first searching signal to the printer port searching part 240.

In order to perform step 34, the printer port searching part 240 searches a printer port of the set interface path corresponding to the predetermined searched network port from the plurality of printer ports in response to the first searching signal input from the network port searching part 220. The printer port searching part 240 outputs a second searching signal to an output terminal OUT2.

In order to perform step 14 of FIG. 2, the data transmission controlling portion 140 controls the printer server to transmit printing data to the printer via the searched set interface paths in response to the controlling result to the interface path input from the path search controlling portion 120A. The data transmission controlling portion 140 outputs a controlling result to the output terminal OUT1.

FIG. 7 is a block diagram of an exemplary data transmission controlling portion 140 of FIG. 5 according to an embodiment of the present invention. The data transmission controlling portion 140A includes a path use checking part 300 and a data transmitting part 320.

In order to perform step 50 of FIG. 4, the set interface path that has been searched by the path search controlling portion 120 is input into the path use checking part 300 through an input terminal IN4, the path use checking part 300 checks whether the searched set interface path is being used for printing different printing data. The path use checking part 300 outputs a checking signal to the data transmitting part 320.

In order to perform step 52 of FIG. 4, the data transmitting part 320 transmits the printing data to the printer corresponding to the searched set interface path through an output terminal OUT3 in response to the checking signal input from the path use checking part 300.

As described above, in the method and apparatus for controlling an interface between clients and printers for printing data according to an embodiment of the present invention, each client's printing data received from a plurality of clients connected to a printer server via a network is simultaneously printed by a plurality of printers.

While this invention has been particularly shown and described with reference to preferred embodiments thereof, it will be understood by those skilled in the art that various changes in form and details may be made therein without departing from the spirit and scope of the invention as defined by the appended claims.

1. A method of controlling an interface between clients and printers for printing data performed by a printer server forming a network, the method comprising:
(a) setting interface paths so that network ports for connecting each of a plurality of clients to the printer server correspond to printer ports for connecting each of a plurality of printers to the printer server;
(b) searching an interface path for printing data received from a client from among the plurality of clients from the set interface paths; and
(c) transmitting the printing data to a printer from among the plurality of printers via the searched interface path.

2. The method of claim 1, wherein step (a) is performed by setting the interface paths in the form of a lookup table.

3. The method of claim 1, wherein step (b) comprises:
determining whether the printing data is received from the clients;
if it is determined that the printing data is received from the clients, searching a network port of the client that has transmitted the printing data to the printer from the plurality of network ports; and
searching a printer port of the interface path corresponding to the searched network port from the plurality of printer ports.

4. The method of claim 1, wherein step (c) comprises:
determining whether the searched set interface path is being used to print different pri nting data; and
if it is determined that the searched interface path is not in use, transmitting the printin g data to the printer corresponding to the searched set interface path.

5. An apparatus for controlling an interface between clients and printers for printing data performed by a printer server forming a network, the apparatus comprising: an interface path setting portion, which sets interface paths so that network ports for connecting each of a plurality of clients to the printer server correspond to printer ports for connecting each of a plurality of printers to the printer server;
a path search controlling portion, which controls the printer server to search the set interface paths for printing data received from a client from among the plurality of clients; and
a data transmission controlling portion, which controls the printer server to transmit the printing data to a printer from among the printers via the searched set interface path.

6. The apparatus of claim 5, wherein the interface path setting portion sets the interface paths in the form of a lookup table.

7. The apparatus of claim 5, wherein the path search controlling portion comprises:
a data reception sensing part, which senses whether the printing data is received from the clients and outputs a sensing signal.
a network port searching part, which searches a network port of the client that has transmitted the printing data to the printer from the plurality of network ports in response to the sensing signal, and outputs a first searching signal; and
a printer port searching part, which searches a printer port of the interface path corresponding to the searched network port from the plurality of printer ports in response to the first searching signal, and outputs a second searching signal.

8. The apparatus of claim 5, wherein the data transmission controlling portion comprises:
a path use checking part, which checks whether the searched interface path is in use for printing different printing data and outputs a checking signal; and
a data transmitting part, which transmits the printing data to the printer corresponding to the searched interface path in response to the checking signal.
